(19) United States
(12) Patent Application Publication
(10) Pub. No.: US 2021/0173178 A1
(43) Pub. Date: Jun. 10, 2021

(54) IRIS LENS ASSEMBLY

(71) Applicant: ZHEJIANG SUNNY OPTICAL CO., LTD, Ningbo City (CN)

(72) Inventor: Lin HUANG, Ningbo City (CN)

(21) Appl. No.: 15/780,111

(22) PCT Filed: Oct. 23, 2017
(86) PCT No.: PCT/CN2017/107328

§ 371 Date: May 30, 2018

(30) Foreign Application Priority Data
May 17, 2017 (CN) 201710346737.2
May 17, 2017 (CN) 201720545624.0

(51) Int. Cl. G02B 9/10; G02B 5/20

(52) U.S. Cl. CPC G02B 9/10; G02B 5/208

(57) ABSTRACT

The present disclosure provides an iris lens assembly. The iris lens assembly includes sequentially a first lens and a second lens from an object side to an image side along an optical axis. The first lens has a positive focal power, an object side surface of the first lens is a convex surface, and an image side surface of the first lens is a concave surface. The second lens has a negative focal power. A spacing distance T12 between the first lens and the second lens on the optical axis and a distance TTL from the object side surface of the first lens to an image plane of the iris lens assembly on the optical axis satisfy: T12/TTL>0.32.

### CROSS-REFERENCE TO RELATED APPLICATIONS

This application claims priorities and rights from Chinese Patent Application No. 201710346737.2, filed with the State Intellectual Property Office of China (SIPO) on May 17, 2017, and Chinese Patent Application No. 201720545624.0 filed with the SIPO on May 17, 2017, the disclosures of which are hereby incorporated by reference in their entireties.

### TECHNICAL FIELD

The present invention relates to an iris lens assembly, and more specifically to an iris lens assembly including two lenses.

### BACKGROUND

In recent years, with the development of science and technology, portable electronic products are gradually emerging, and portable electronic products having camera function are increasingly liked by people. Therefore, market demands for camera lens assemblies suitable for the portable electronic products are gradually increasing. Currently, an often used photosensitive element in a camera lens assembly is generally a CCD (charge-coupled device) or a CMOS (complementary metal-oxide semiconductor). With the improvement of semiconductor processing technology, optical systems tend to have higher pixels, and pixel sizes on the chips become smaller and smaller. Accordingly, higher requirements on high image quality and the miniaturization of the lens assemblies used in combination have been brought forward.

In the security field in particular, requirements on lens assemblies with iris recognition also become higher and higher. Not only a compact structure of the lens assembly needs to be ensured, but also brightness and resolution of the lens assembly need to be enhanced, so as to improve the recognition accuracy of the lens assembly.

Therefore, there is a need to provide a compact-type iris lens assembly having a high brightness, a high resolution and a simple structure.

### SUMMARY

The technical solutions provided by the present disclosure solve at least some of the above-mentioned technical problems.

An iris lens assembly is provided according to an aspect of the present disclosure. The iris lens assembly includes sequentially a first lens and a second lens from an object side to an image side along an optical axis. The first lens has a positive focal power, an object side surface of the first lens is a convex surface, and an image side surface of the first lens is a concave surface. The second lens has a negative focal power. A spacing distance T12 between the first lens and the second lens on the optical axis and a distance TTL from the object side surface of the first lens to an image plane of the iris lens assembly on the optical axis may satisfy: T12/TTL>0.32.

In the present disclosure, multiple lenses (e.g., two lenses) are used. By reasonably distributing focal powers and surface types of lenses in an optical lens assembly, the system possesses the advantages of high relative illumination and high resolution in the process of simplifying the structure of the lens assembly.

An iris lens assembly is provided according to another aspect of the present disclosure. The iris lens assembly includes sequentially a first lens and a second lens from an object side to an image side along an optical axis. The first lens has a positive focal power, an object side surface of the first lens is a convex surface, and an image side surface of the first lens is a concave surface. The second lens has a negative focal power. An effective radius DT11 of the object side surface of the first lens and an effective radius DT22 of an image side surface of the second lens may satisfy: 0.7<DT11/DT22<1.

In an implementation, a maximum thickness ET1max of the first lens in a direction parallel to the optical axis and a minimum thickness ET1min of the first lens in the direction parallel to the optical axis may satisfy: 1<ET1max/ET1min<1.45.

In an implementation, the iris lens assembly further includes an electronic photosensitive element disposed on the image plane, wherein a maximum incident angle CRAmax of a chief incident ray on the electronic photosensitive element may satisfy: CRAmax<30°.

In an implementation, an edge thickness ET1 of the first lens and a center thickness CT1 of the first lens on the optical axis may satisfy: 0.5<ET1/CT1<1.

In an implementation, the iris lens assembly further includes a filter arranged between the second lens and the image plane, and the filter is an infrared (IR) filter.

In an implementation, a bandpass wave band of the infrared (IR) filter may range from about 785 nm to about 835 nm.

In an implementation, the distance TTL from the object side surface of the first lens to the image plane of the iris lens assembly on the optical axis, a half of a diagonal length ImgH of an effective pixel area of the electronic photosensitive element on the image plane of the iris lens assembly, and a total effective focal length f of the iris lens assembly may satisfy: 0.4 mm⁻¹<TTL/(ImgH*f)<0.7 mm⁻¹.

In an implementation, an effective radius DT12 of the image side surface of the first lens and the effective radius DT22 of the image side surface of the second lens may satisfy: 0.7<DT12/DT22<1.

In an implementation, the effective radius DT22 of the image side surface of the second lens and the half of the diagonal length ImgH of the effective pixel area of the electronic photosensitive element on the image plane of the iris lens assembly may satisfy: 0.5<DT22/ImgH<1.

In an implementation, the iris lens assembly further includes an aperture diaphragm arranged between the object side and the first lens, and a radius of curvature R4 of the image side surface of the second lens and the total effective focal length f of the iris lens assembly may satisfy: |R4/f|<3.

In an implementation, the iris lens assembly further includes an aperture diaphragm arranged between the first lens and the second lens, and a radius of curvature R2 of the image side surface of the first lens and an effective focal length f1 of the first lens may satisfy: 0.5<R2/f1<0.9.

Through the above configurations, the iris lens assembly may further possess at least one of the beneficial effects, for example, a high recognition accuracy, effectively correcting aberrations, effectively correcting a field curvature, shortening the total length of the system, etc.

### BRIEF DESCRIPTION OF THE DRAWINGS

By describing non-limiting implementations below in detail with reference to the accompanying drawings, other features, objectives and advantages of the present invention will be more apparent. In the accompanying drawings:

FIG. 1 illustrates a schematic structural diagram of an iris lens assembly according to embodiment 1 of the present disclosure;

FIG. 2A illustrates a longitudinal aberration curve of the iris lens assembly according to embodiment 1;

FIG. 2B illustrates an astigmatic curve of the iris lens assembly according to embodiment 1;

FIG. 2C illustrates a distortion curve of the iris lens assembly according to embodiment 1;

FIG. 2D illustrates a lateral color curve of the iris lens assembly according to embodiment 1;

FIG. 2E illustrates a relative illumination curve of the iris lens assembly according to embodiment 1;

FIG. 3 illustrates a schematic structural diagram of an iris lens assembly according to embodiment 2 of the present disclosure;

FIG. 4A illustrates a longitudinal aberration curve of the iris lens assembly according to embodiment 2;

FIG. 4B illustrates an astigmatic curve of the iris lens assembly according to embodiment 2;

FIG. 4C illustrates a distortion curve of the iris lens assembly according to embodiment 2;

FIG. 4D illustrates a lateral color curve of the iris lens assembly according to embodiment 2;

FIG. 4E illustrates a relative illumination curve of the iris lens assembly according to embodiment 2;

FIG. 5 illustrates a schematic structural diagram of an iris lens assembly according to embodiment 3 of the present disclosure;

FIG. 6A illustrates a longitudinal aberration curve of the iris lens assembly according to embodiment 3;

FIG. 6B illustrates an astigmatic curve of the iris lens assembly according to embodiment 3;

FIG. 6C illustrates a distortion curve of the iris lens assembly according to embodiment 3;

FIG. 6D illustrates a lateral color curve of the iris lens assembly according to embodiment 3;

FIG. 6E illustrates a relative illumination curve of the iris lens assembly according to embodiment 3;

FIG. 7 illustrates a schematic structural diagram of an iris lens assembly according to embodiment 4 of the present disclosure;

FIG. 8A illustrates a longitudinal aberration curve of the iris lens assembly according to embodiment 4;

FIG. 8B illustrates an astigmatic curve of the iris lens assembly according to embodiment 4;

FIG. 8C illustrates a distortion curve of the iris lens assembly according to embodiment 4;

FIG. 8D illustrates a lateral color curve of the iris lens assembly according to embodiment 4;

FIG. 8E illustrates a relative illumination curve of the iris lens assembly according to embodiment 4;

FIG. 9 illustrates a schematic structural diagram of an iris lens assembly according to embodiment 5 of the present disclosure;

FIG. 10A illustrates a longitudinal aberration curve of the iris lens assembly according to embodiment 5;

FIG. 10B illustrates an astigmatic curve of the iris lens assembly according to embodiment 5;

FIG. 10C illustrates a distortion curve of the iris lens assembly according to embodiment 5;

FIG. 10D illustrates a lateral color curve of the iris lens assembly according to embodiment 5;

FIG. 10E illustrates a relative illumination curve of the iris lens assembly according to embodiment 5;

FIG. 11 illustrates a schematic structural diagram of an iris lens assembly according to embodiment 6 of the present disclosure;

FIG. 12A illustrates a longitudinal aberration curve of the iris lens assembly according to embodiment 6;

FIG. 12B illustrates an astigmatic curve of the iris lens assembly according to embodiment 6;

FIG. 12C illustrates a distortion curve of the iris lens assembly according to embodiment 6;

FIG. 12D illustrates a lateral color curve of the iris lens assembly according to embodiment 6; and

FIG. 12E illustrates a relative illumination curve of the iris lens assembly according to embodiment 6.

### DETAILED DESCRIPTION OF EMBODIMENTS

Various aspects of the present disclosure will be described in more detail with reference to the accompanying drawings, so as to better understand the present disclosure. It should be appreciated that the detailed description is merely an explanation for the exemplary embodiments of the present disclosure, rather than a limitation to the scope of the present disclosure in any way. The same reference numerals designate the same elements throughout this specification. The expression “and/or” includes any and all combinations of one or more of the associated listed items.

It should be noted that, in the specification, expressions, such as “first” and “second” are merely used to distinguish one feature from another feature, rather than represent any limitations to the feature. Thus, a first lens discussed below may also be termed a second lens without departing from the teachings of the present disclosure.

In the accompanying drawings, for the convenience of explanation, the thicknesses, dimensions and shapes of lenses have been slightly exaggerated. Specifically, shapes of spherical surfaces or aspheric surfaces shown in the accompanying drawings are illustrated by examples. That is, shapes of the spherical surfaces or aspheric surfaces are not limited to the shapes of the spherical surfaces or the aspheric surfaces shown in the accompanying drawings. The accompanying drawings are merely examples, not strictly drawn to scale.

In addition, a paraxial area indicates an area near an optical axis. In the present disclosure, a surface closest to the object in each lens is referred to as an object side surface, and a surface closest to an image plane in each lens is referred to as an image side surface.

It should be further understood that the terms “comprising,” “including,” “having” and variants thereof, when used in this specification, specify the presence of stated characteristics, entireties, steps, operations, elements and/or components, but do not exclude the presence or addition of one or more other characteristics, entireties, steps, operations, elements, components and/or combinations thereof. In addition, expressions, such as “at least one of,” when preceding a list of elements, modify the entire list of elements rather than an individual element in the list. Further, the use of “may,” when describing embodiments of the present disclosure, relates to “one or more embodiments of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that the embodiments in the present disclosure and the features in the embodiments may be combined with each other on a non-conflict basis. The present disclosure will be described below in detail with reference to the accompanying drawings and in combination with the embodiments.

Characteristics, principles and other aspects of the present disclosure will be described below in detail.

An iris lens assembly according to exemplary implementations of the present disclosure includes, for example, two lenses (i.e., a first lens and a second lens). The first lens and the second lens are arranged in sequence from an object side to an image side along an optical axis.

In the exemplary implementations, the first lens may have a positive focal power, an object side surface of the first lens is a convex surface and an image side surface of the first lens is a concave surface. The second lens may have a negative focal power.

Alternatively, the iris lens assembly may further include a filter arranged between the second lens and an image plane. The filter maybe an infrared (IR) filter, and the infrared (IR) filter may be used to filter noise from visible light to achieve a high performance recognition effect of the lens assembly. A bandpass wave band of the filter may range from about 785 nm to about 835 nm, to ensure that irises of eye colors of different races can be accurately identified.

In the exemplary implementations, a spacing distance T12 between the first lens and the second lens on the optical axis and a distance TTL from the object side surface of the first lens to an image plane of the iris lens assembly on the optical axis may satisfy: T12/TTL>0.32, and more specifically, T12 and TTL may further satisfy: 0.33≤T12/TTL≤0.43. By reasonably distributing the spacing distance T12 between the first lens and the second lens on the optical axis and the distance TTL from the object side surface of the first lens to the image plane of the iris lens assembly on the optical axis, an incident angle of light may be reduced, optical aberrations may be reduced, thereby improving the resolution of the lens assembly.

To realize miniaturization of the lens assembly, effective radii of surfaces of the lenses may be optimized. For example, an effective radius DT11 of the object side surface of the first lens and an effective radius DT22 of an image side surface of the second lens may satisfy: 0.7<DT11/DT22<1, and more specifically, DT11 and DT22 may further satisfy: 0.80≤DT11/DT22≤0.99. For another example, an effective radius DT12 of the image side surface of the first lens and the effective radius DT22 of the image side surface of the second lens may satisfy: 0.7<DT12/DT22<1, and more specifically, DT12 and DT22 may further satisfy: 0.72≤DT12/DT22≤0.86.

In addition, to achieve a good combination with the chip while the miniaturization of the size of the lens assembly is realized, the effective radius DT12 of the image side surface of the second lens and ImgH, ImgH being a half of a diagonal length of an effective pixel area of an electronic photosensitive element on the image plane of the iris lens assembly, may be reasonably distributed. DT22 and ImgH may satisfy: 0.5<DT22/ImgH<1, and more specifically, DT22 and ImgH may further satisfy: 0.56≤DT22/ImgH≤0.79.

In the exemplary implementations, a maximum thickness ET1max of the first lens in a direction parallel to the optical axis and a minimum thickness ET1min of the first lens in the direction parallel to the optical axis may satisfy: 1<ET1max/ET1min<1.45, and more specifically, ET1max and ET1min may further satisfy: 1.10≤ET1max/ET1min≤1.40, to ensure the focal power of the first lens, thereby ensuring the recognition accuracy of the iris lens assembly.

In the exemplary implementations, an edge thickness ET1 of the first lens and a center thickness CT1 of the first lens on the optical axis may satisfy: 0.5<ET1/CT1<1, and more specifically, ET1 and CT1 may further satisfy: 0.53≤ET1/CT1≤0.74, to ensure that the overall focal power of the first lens from the center to the edge is positive, thereby ensuring the recognition accuracy of the iris lens assembly.

A maximum incident angle of a chief incident ray on the electronic photosensitive element may also be optimized, in order to effectively reduce the drift of the film system at an incident angle of the peripheral field of view, and reduce the bandwidth of the film system, which reduces interference effects. The maximum incident angle CRAmax of the chief incident ray on the electronic photosensitive element may satisfy: CRAmax<30°, and more specifically, CRAmax may further satisfy: 24.14°≤CRAmax≤29.03°. Such a configuration can also effectively improve the photosensitive efficiency of the light entering the chip, thereby enhancing the recognition effect of the iris lens assembly.

The distance TTL from the object side surface of the first lens to the image plane of the iris lens assembly on the optical axis, the half of the diagonal length ImgH of the effective pixel area of the electronic photosensitive element on the image plane of the iris lens assembly, and a total effective focal length f of the iris lens assembly may satisfy: 0.4 mm⁻¹<TTL/(ImgH*f)<0.7 mm⁻¹, and more specifically, TTL, ImgH and f may further satisfy: 0.61 mm⁻¹≤TTL/(ImgH*f)≤0.67 mm⁻¹, to ensure that the iris lens assembly possesses enough recognition accuracy while ensuring that the size of the lens assembly is as small as possible.

In the exemplary implementations, an aperture diaphragm for limiting light beams may be arranged between the object side and the first lens to improve the image quality of the lens assembly. At this moment, a radius of curvature R4 of the image side surface of the second lens and the total effective focal length f of the iris lens assembly may satisfy: |R4/f|<3, and more specifically, R4 and f may further satisfy: 0.65≤|R4/f|≤2.98, to achieve the high brightness and high resolution of the iris lens assembly.

In other exemplary implementations, an aperture diaphragm for limiting light beams may be arranged between the first lens and the second lens to improve the image quality of the lens assembly. At this moment, a radius of curvature R2 of the image side surface of the first lens and an effective focal length f1 of the first lens may satisfy: 0.5<R2/f1<0.9, and more specifically, 0.73≤R2/f1≤0.81, to reduce the influence of a comatic aberration and improve the resolution of lens assembly.

The iris lens assembly according to the above implementations of the present disclosure may use multiple lenses. By reasonably distributing the focal powers, surface types and center thicknesses of various lenses, the axial spacing distances between the various lenses, and so on, the structure of the lens assembly may be effectively compacted and the miniaturization of the lens assembly may bey ensured, so that the iris lens assembly is more conducive to the production and processing and may be applied to portable electronic products. In the implementations of the present disclosure, at least one of the mirror surfaces of the lenses is an aspheric mirror surface. An aspheric lens is characterized in that its curvature continuously changes from the lens center to the periphery. In contrast to a spherical lens having a constant curvature from the lens center to the periphery, the aspheric lens has a better radius-of-curvature characteristic, and has the advantages of reducing the distortion aberration and the astigmatic aberration. The use of the aspheric lens can eliminate as much as possible the aberration that occurs during imaging, thereby improving the image quality.

However, it should be understood by those skilled in the art that, in a situation without departing from the technical solution claimed by the present disclosure, the number of lenses forming the lens assembly may be changed, to obtain the various results and advantages described in the specification of the present disclosure. For instance, in the descriptions of the implementations, an iris lens assembly having two lenses is described as an example, but the iris lens assembly is not limited to include two lenses. If necessary, the iris lens assembly may also include other numbers of lenses.

Specific embodiments applicable to the iris lens assembly of the above implementations will be further described below with reference to the accompanying drawings.

### Embodiment 1

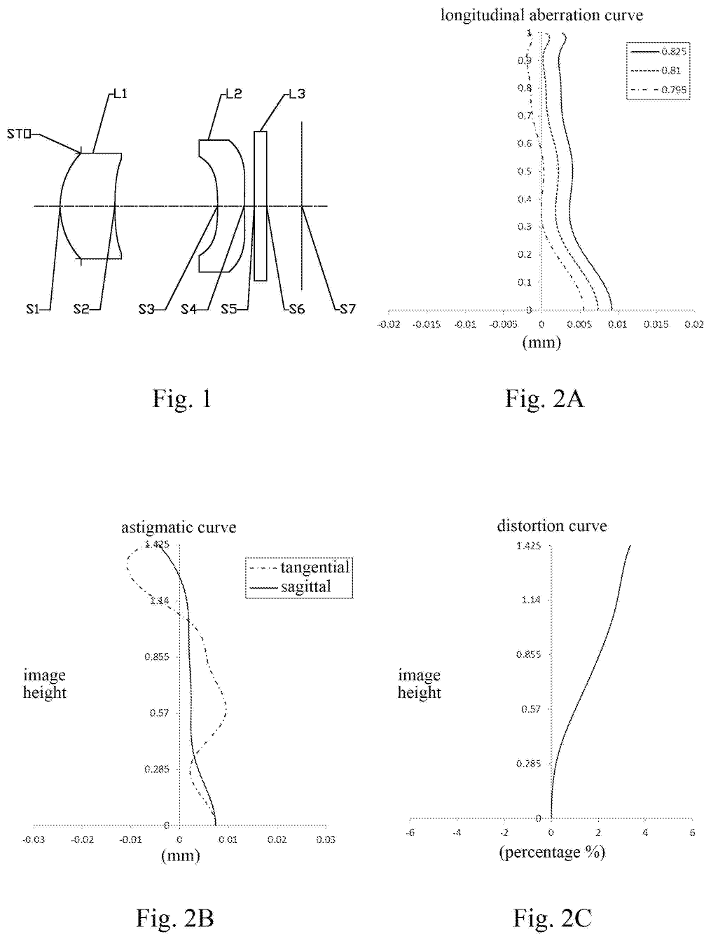

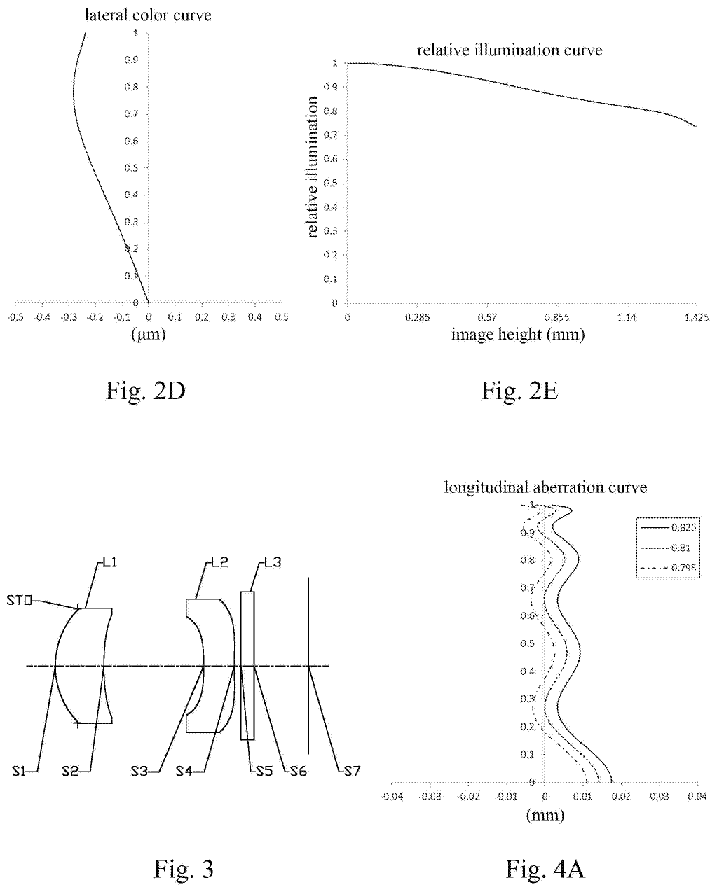

An iris lens assembly according to embodiment 1 of the present disclosure is described below with reference to FIGS. 1-2E. FIG. 1 illustrates a schematic structural diagram of the iris lens assembly according to embodiment 1 of the present disclosure.

As shown in FIG. 1, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 1 shows the surface type, the radius of curvature, the thickness, the material and the conic coefficient of each lens of the iris lens assembly in embodiment 1. The radius of curvature and the thickness are shown in millimeters (mm).

TABLE 1

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| STO | spherical | infinite | −0.3561 | | | |
| S1 | aspheric | 1.3231 | 0.9308 | 1.492 | 81.61 | 0.4593 |
| S2 | aspheric | 4.3707 | 1.7510 | | | 1.0000 |
| S3 | aspheric | −5.4140 | 0.4544 | 1.622 | 23.53 | 1.0000 |
| S4 | aspheric | 5.5684 | 0.1692 | | | −63.9236 |
| S5 | spherical | infinite | 0.2100 | 1.517 | 64.17 | |
| S6 | spherical | infinite | 0.6000 | | | |
| S7 | spherical | infinite | | | | |

In this embodiment, an iris lens assembly having two lenses is used as an example. By reasonably distributing the focal lengths and the surface types of the lenses, the total length of the lens assembly is effectively reduced, the relative illumination of the lens assembly and the recognition accuracy of the lens assembly are effectively improved. Meanwhile, various aberrations are corrected, and the resolution and the image quality of the iris lens assembly are improved. A surface type x of each aspheric surface is defined by the following formula:

$$x = \frac{c {h}^{2}}{1 + \sqrt{1 - ( k + 1 ) {c}^{2} {h}^{2}}} + \sum A i {h}^{i} \qquad ( 1 )$$

When an aspheric surface is at a height h along the optical axis, x is the distance sagittal height to the vertex of the aspheric surface; c is the paraxial curvature of the aspheric surface, and c=1/R (i.e., the paraxial curvature c is the reciprocal of the radius of curvature R in Table 1 above); k is the conic coefficient (given in Table 1 above); and Ai is the correction coefficient of the i-th order of the aspheric surface. Table 2 below shows the high-order coefficients A₄, A₆, A₈, A₁₀, A₁₂, A₁₄ and A₁₆ that can be applied to the aspheric mirror surfaces S1-S4 in embodiment 1.

TABLE 2

| surface | | | | | | | |
|---|---|---|---|---|---|---|---|
| number | A4 | A6 | A8 | A10 | A12 | A14 | A16 |
| S1 | −2.7825E−02 | −2.3370E−02 | 4.0932E−02 | −1.3584E−01 | 1.5653E−01 | −8.2473E−02 | 0.0000E+00 |
| S2 | 4.1007E−02 | 1.2926E−01 | −4.3835E−01 | 1.1608E+00 | −1.4200E+00 | 7.5082E−01 | 0.0000E+00 |
| S3 | −3.0579E−01 | −7.7277E−01 | 4.4362E+00 | −1.5260E+01 | 2.8847E+01 | −2.9261E+01 | 1.2011E+01 |
| S4 | −2.2537E−01 | −4.8696E−02 | 3.7403E−01 | −8.0992E−01 | 8.8518E−01 | −5.0706E−01 | 1.1906E−01 |

Table 3 shows the total effective focal length f of the iris lens assembly of embodiment 1, the effective focal length f1 of the first lens L1, the effective focal length f2 of the second lens L2, the total optical length TTL of the iris lens assembly (i.e., the distance from the object side surface S1 of the first lens L1 to the image plane S7 of the iris lens assembly on the optical axis), and the half of the diagonal length ImgH of the effective pixel area of the electronic photosensitive element on the image plane S7 of the iris lens assembly.

TABLE 3

| parameter | f (mm) | f1 (mm) | f2 (mm) | TTL (mm) | ImgH (mm) |
|---|---|---|---|---|---|
| numerical value | 4.30 | 3.50 | −4.35 | 4.12 | 1.43 |

According to Table 3, it can be obtained that the total optical length TTL of the iris lens assembly, the half of the diagonal length ImgH of the effective pixel area of the electronic photosensitive element on the image plane S7, and the total effective focal length f of the iris lens assembly satisfy: TTL/(ImgH*f)=0.67 mm⁻¹. In view of Table 1 and Table 3, it can be obtained that the radius of curvature R4 of the image side surface S4 of the second lens L2 and the total effective focal length f of the iris lens assembly satisfy: |R4/f|=1.30, and the spacing distance T12 between the first lens L1 and the second lens L2 on the optical axis and the total optical length TTL of the iris lens assembly satisfy: T12/TTL=0.43.

In this embodiment, the edge thickness ET1 of the first lens L1 and the center thickness CT1 of the first lens L1 on the optical axis satisfy: ET1/CT1=0.74. The effective radius DT11 of the object side surface S1 of the first lens L1 and the effective radius DT22 of the image side surface S4 of the second lens satisfy: DT11/DT22=0.80. The effective radius DT12 of the image side surface S2 of the first lens L1 and the effective radius DT22 of the image side surface S4 of the second lens satisfy: DT12/DT22=0.72. The effective radius DT22 of the image side surface S4 of the second lens and ImgH, ImgH being the half of the diagonal length of the effective pixel area of the electronic photosensitive element on the image plane S7, satisfy: DT22/ImgH=0.79. The maximum thickness ET1max of the first lens L1 in the direction parallel to the optical axis and the minimum thickness ET1min of the first lens L1 in the direction parallel to the optical axis satisfy: ET1max/ET1min=1.20. The maximum incident angle CRAmax of the chief incident ray on the electronic photosensitive element satisfies: CRAmax=24.14°.

FIG. 2A illustrates a longitudinal aberration curve of the iris lens assembly according to embodiment 1, representing deviations of focal points of light of different wavelengths converged after passing through the iris lens assembly. FIG. 2B illustrates an astigmatic curve of the iris lens assembly according to embodiment 1, representing a curvature of a meridional image plane and a curvature of a sagittal image plane. FIG. 2C illustrates a distortion curve of the iris lens assembly according to embodiment 1, representing amounts of distortion at different viewing angles. FIG. 2D illustrates a lateral color curve of the iris lens assembly according to embodiment 1, representing deviations of different image heights on an image plane after light passes through the iris lens assembly. FIG. 2E illustrates a relative illumination curve of the iris lens assembly according to embodiment 1, representing relative illumination corresponding to different image heights on the image plane. It can be known according to FIGS. 2A-2E that the iris lens assembly provided in embodiment 1 can achieve a good image quality.

### Embodiment 2

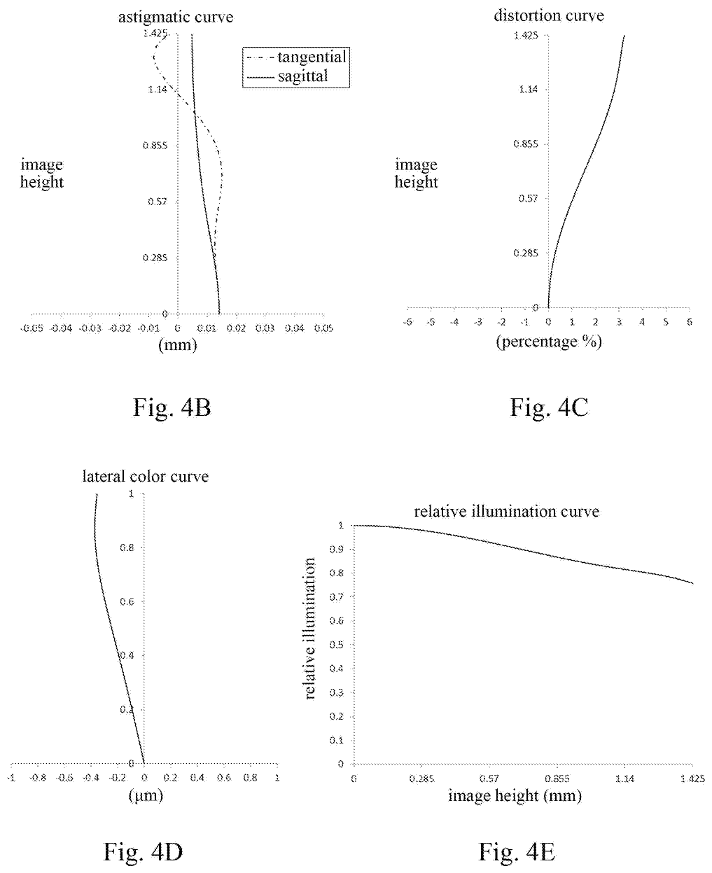

An iris lens assembly according to embodiment 2 of the present disclosure is described below with reference to FIGS. 3-4E. In this embodiment and the following embodiments, for the purpose of brevity, the description of parts similar to those in embodiment 1 will be omitted. FIG. 3 illustrates a schematic structural diagram of the iris lens assembly according to embodiment 2 of the present disclosure.

As shown in FIG. 3, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 4 shows the surface type, the radius of curvature, the thickness, the material and the conic coefficient of each lens of the iris lens assembly in embodiment 2. The radius of curvature and the thickness are shown in millimeters (mm). Table 5 shows the high-order coefficients A₄, A₆, A₈, A₁₀, A₁₂, A₁₄ and A₁₆ that can be applied to the aspheric mirror surfaces in embodiment 2. Table 6 shows the total effective focal length f of the iris lens assembly, the effective focal length f1 of the first lens L1, the effective focal length f2 of the second lens L2, the total optical length TTL of the iris lens assembly, and the half of the diagonal length ImgH of the effective pixel area of the electronic photosensitive element on the image plane S7 of the iris lens assembly of embodiment 2. A surface type of each aspheric surface may be defined by the formula (1) provided in embodiment 1.

TABLE 4

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| STO | spherical | infinite | −0.3582 | | | |
| S1 | aspheric | 1.3193 | 0.7814 | 1.537 | 56.11 | 0.5705 |
| S2 | aspheric | 3.7234 | 1.6091 | | | −99.0000 |
| S3 | aspheric | −4.2966 | 0.4926 | 1.622 | 23.53 | −14.7456 |
| S4 | aspheric | 11.5314 | 0.1064 | | | 1.0000 |
| S5 | spherical | infinite | 0.2100 | 1.517 | 64.17 | |
| S6 | spherical | infinite | 0.8749 | | | |
| S7 | spherical | infinite | | | | |

TABLE 5

| surface | | | | | | | |
|---|---|---|---|---|---|---|---|
| number | A4 | A6 | A8 | A10 | A12 | A14 | A16 |
| S1 | −2.6160E−02 | −9.8112E−02 | 3.2590E−01 | −7.3463E−01 | 7.5777E−01 | −3.2925E−01 | 0.0000E+00 |
| S2 | 2.6250E−01 | −5.4990E−01 | 1.2654E+00 | −1.7467E+00 | 1.3458E+00 | −3.6374E−01 | 0.0000E+00 |
| S3 | −3.3351E−01 | −2.7563E−01 | 4.8402E−01 | −4.3714E−01 | −1.9811E+00 | 3.7155E+00 | −2.4914E+00 |
| S4 | −2.0495E−01 | −7.0167E−02 | 2.8496E−01 | −4.8863E−01 | 4.2976E−01 | −2.0449E−01 | 4.1370E−02 |

TABLE 6

| parameter | f (mm) | f1 (mm) | f2 (mm) | TTL (mm) | ImgH (mm) |
|---|---|---|---|---|---|
| numerical value | 4.30 | 3.42 | −4.98 | 4.07 | 1.43 |

FIG. 4A illustrates a longitudinal aberration curve of the iris lens assembly according to embodiment 2, representing deviations of focal points of light of different wavelengths converged after passing through the iris lens assembly. FIG. 4B illustrates an astigmatic curve of the iris lens assembly according to embodiment 2, representing a curvature of a meridional image plane and a curvature of a sagittal image plane. FIG. 4C illustrates a distortion curve of the iris lens assembly according to embodiment 2, representing amounts of distortion at different viewing angles. FIG. 4D illustrates a lateral color curve of the iris lens assembly according to embodiment 2, representing deviations of different image heights on an image plane after light passes through the iris lens assembly. FIG. 4E illustrates a relative illumination curve of the iris lens assembly according to embodiment 2, representing relative illumination corresponding to different image heights on the image plane. It can be known according to FIGS. 4A-4E that the iris lens assembly provided in embodiment 2 can achieve a good image quality.

### Embodiment 3

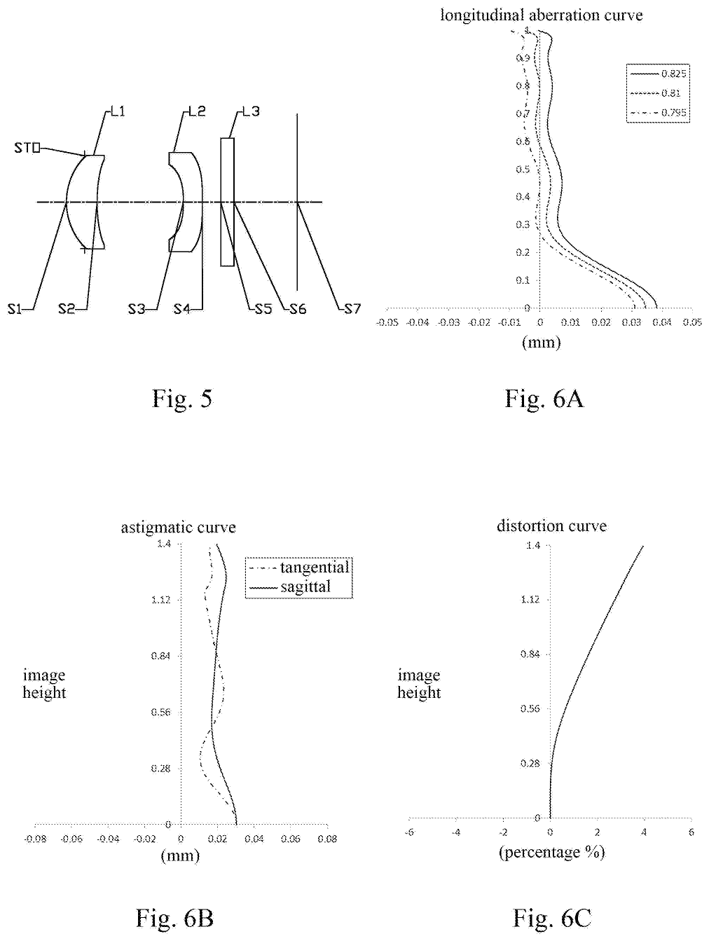

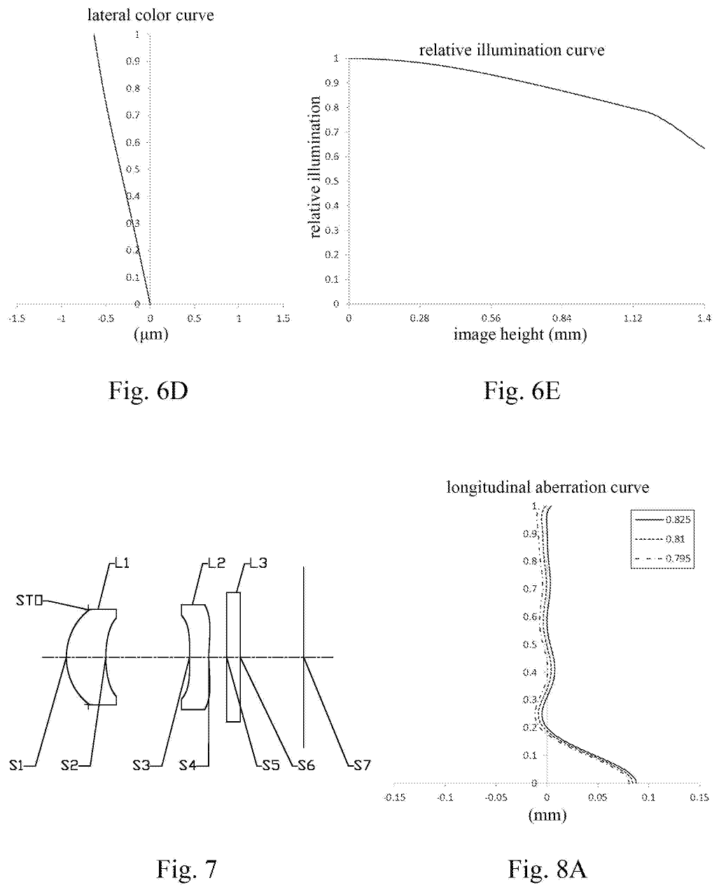

An iris lens assembly according to embodiment 3 of the present disclosure is described below with reference to FIGS. 5-6E. FIG. 5 illustrates a schematic structural diagram of the iris lens assembly according to embodiment 3 of the present disclosure.

As shown in FIG. 5, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 7 shows the surface type, the radius of curvature, the thickness, the material and the conic coefficient of each lens of the iris lens assembly in embodiment 3. The radius of curvature and the thickness are shown in millimeters (mm). Table 8 shows the high-order coefficients A₄, A₆, A₈, A₁₀, A₁₂, A₁₄ and A₁₆ that can be applied to the aspheric mirror surfaces in embodiment 3. Table 9 shows the total effective focal length f of the iris lens assembly, the effective focal length f1 of the first lens L1, the effective focal length f2 of the second lens L2, the total optical length TTL of the iris lens assembly, and the half of the diagonal length ImgH of the effective pixel area of the electronic photosensitive element on the image plane S7 of the iris lens assembly of embodiment 3. A surface type of each aspheric surface may be defined by the formula (1) provided in embodiment 1.

TABLE 7

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| STO | spherical | infinite | −0.2893 | | | |
| S1 | aspheric | 1.0450 | 0.4870 | 1.537 | 56.11 | 0.4464 |
| S2 | aspheric | 2.6547 | 1.3711 | | | −93.7918 |
| S3 | aspheric | −1.7748 | 0.3000 | 1.622 | 23.53 | −43.7008 |
| S4 | aspheric | −12.8176 | 0.2919 | | | 1.0000 |
| S5 | spherical | infinite | 0.2100 | 1.517 | 64.17 | |
| S6 | spherical | infinite | 1.0029 | | | |
| S7 | spherical | infinite | | | | |

TABLE 8

| surface | | | | | | | |
|---|---|---|---|---|---|---|---|
| number | A4 | A6 | A8 | A10 | A12 | A14 | A16 |
| S1 | −4.7633E−02 | −1.5765E−01 | 9.3141E−01 | −4.1530E+00 | 9.2021E+00 | −1.0447E+01 | 4.5212E+00 |
| S2 | 6.1085E−01 | −2.3867E+00 | 9.6314E+00 | −2.8191E+01 | 5.7935E+01 | −7.1768E+01 | 4.0952E+01 |
| S3 | −1.5086E+00 | 2.0247E+00 | 1.7414E−01 | −4.1911E+01 | 1.6557E+02 | −2.9444E+02 | 1.9063E+02 |
| S4 | −4.4143E−01 | −1.6215E−01 | 2.5326E+00 | −9.6285E+00 | 1.8539E+01 | −1.8475E+01 | 7.5187E+00 |

TABLE 9

| parameter | f (mm) | f1 (mm) | f2 (mm) | TTL (mm) | ImgH (mm) |
|---|---|---|---|---|---|
| numerical value | 4.30 | 2.90 | −3.35 | 3.66 | 1.40 |

FIG. 6A illustrates a longitudinal aberration curve of the iris lens assembly according to embodiment 3, representing deviations of focal points of light of different wavelengths converged after passing through the iris lens assembly. FIG. 6B illustrates an astigmatic curve of the iris lens assembly according to embodiment 3, representing a curvature of a meridional image plane and a curvature of a sagittal image plane. FIG. 6C illustrates a distortion curve of the iris lens assembly according to embodiment 3, representing amounts of distortion at different viewing angles. FIG. 6D illustrates a lateral color curve of the iris lens assembly according to embodiment 3, representing deviations of different image heights on an image plane after light passes through the iris lens assembly. FIG. 6E illustrates a relative illumination curve of the iris lens assembly according to embodiment 3, representing relative illumination corresponding to different image heights on the image plane. It can be known according to FIGS. 6A-6E that the iris lens assembly provided in embodiment 3 can achieve a good image quality.

### Embodiment 4

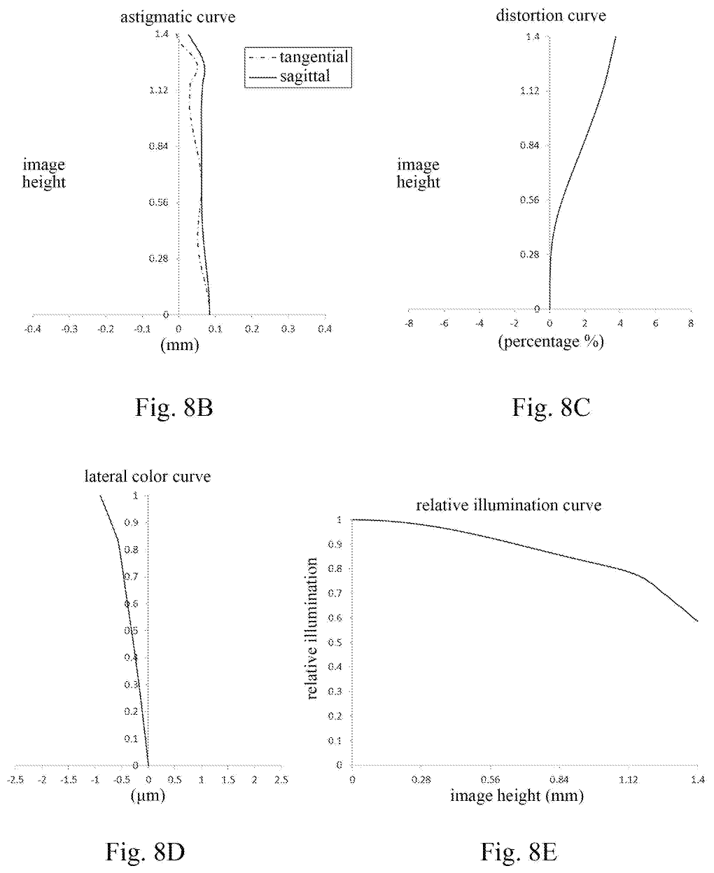

An iris lens assembly according to embodiment 4 of the present disclosure is described below with reference to FIGS. 7-8E. FIG. 7 illustrates a schematic structural diagram of the iris lens assembly according to embodiment 4 of the present disclosure.

As shown in FIG. 7, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 10 shows the surface type, the radius of curvature, the thickness, the material and the conic coefficient of each lens of the iris lens assembly in embodiment 4. The radius of curvature and the thickness are shown in millimeters (mm). Table 11 shows the high-order coefficients A₄, A₆, A₈, A₁₀, A₁₂, A₁₄ and A₁₆ that can be applied to the aspheric mirror surfaces in embodiment 4. Table 12 shows the total effective focal length f of the iris lens assembly, the effective focal length f1 of the first lens L1, the effective focal length f2 of the second lens L2, the total optical length TTL of the iris lens assembly, and the half of the diagonal length ImgH of the effective pixel area of the electronic photosensitive element on the image plane S7 of the iris lens assembly of embodiment 4. A surface type of each aspheric surface may be defined by the formula (1) provided in embodiment 1.

TABLE 10

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| STO | spherical | infinite | −0.3389 | | | |
| S1 | aspheric | 0.9738 | 0.6113 | 1.537 | 56.11 | 0.2641 |
| S2 | aspheric | 1.6960 | 1.2992 | | | −99.0000 |
| S3 | aspheric | 187.0863 | 0.3000 | 1.622 | 23.53 | 1.0000 |
| S4 | aspheric | 2.7991 | 0.2747 | | | −21.3055 |
| S5 | spherical | infinite | 0.2100 | 1.517 | 64.17 | |
| S6 | spherical | infinite | 0.9857 | | | |
| S7 | spherical | infinite | | | | |

TABLE 11

| surface | | | | | | | |
|---|---|---|---|---|---|---|---|
| number | A4 | A6 | A8 | A10 | A12 | A14 | A16 |
| S1 | 1.2370E−02 | −4.5618E−01 | 2.8196E+00 | −9.8281E+00 | 1.9081E+01 | −1.9479E+01 | 8.1856E+00 |
| S2 | 2.2084E+00 | −1.8264E+01 | 1.2729E+02 | −5.7248E+02 | 1.5904E+03 | −2.4535E+03 | 1.6269E+03 |
| S3 | −4.9117E−01 | −2.3555E+00 | 1.9208E+01 | −9.0295E+01 | 2.3731E+02 | −3.3491E+02 | 1.9467E+02 |
| S4 | −4.1747E−01 | 4.1254E−02 | 9.9817E−01 | −4.0704E+00 | 7.8205E+00 | −7.7140E+00 | 3.1000E+00 |

TABLE 12

| parameter | f (mm) | f1 (mm) | f2 (mm) | TTL (mm) | ImgH (mm) |
|---|---|---|---|---|---|
| numerical value | 4.30 | 3.29 | −4.58 | 3.68 | 1.40 |

FIG. 8A illustrates a longitudinal aberration curve of the iris lens assembly according to embodiment 4, representing deviations of focal points of light of different wavelengths converged after passing through the iris lens assembly. FIG. 8B illustrates an astigmatic curve of the iris lens assembly according to embodiment 4, representing a curvature of a meridional image plane and a curvature of a sagittal image plane. FIG. 8C illustrates a distortion curve of the iris lens assembly according to embodiment 4, representing amounts of distortion at different viewing angles. FIG. 8D illustrates a lateral color curve of the iris lens assembly according to embodiment 4, representing deviations of different image heights on an image plane after light passes through the iris lens assembly. FIG. 8E illustrates a relative illumination curve of the iris lens assembly according to embodiment 4, representing relative illumination corresponding to different image heights on the image plane. It can be known according to FIGS. 8A-8E that the iris lens assembly provided in embodiment 4 can achieve a good image quality.

### Embodiment 5

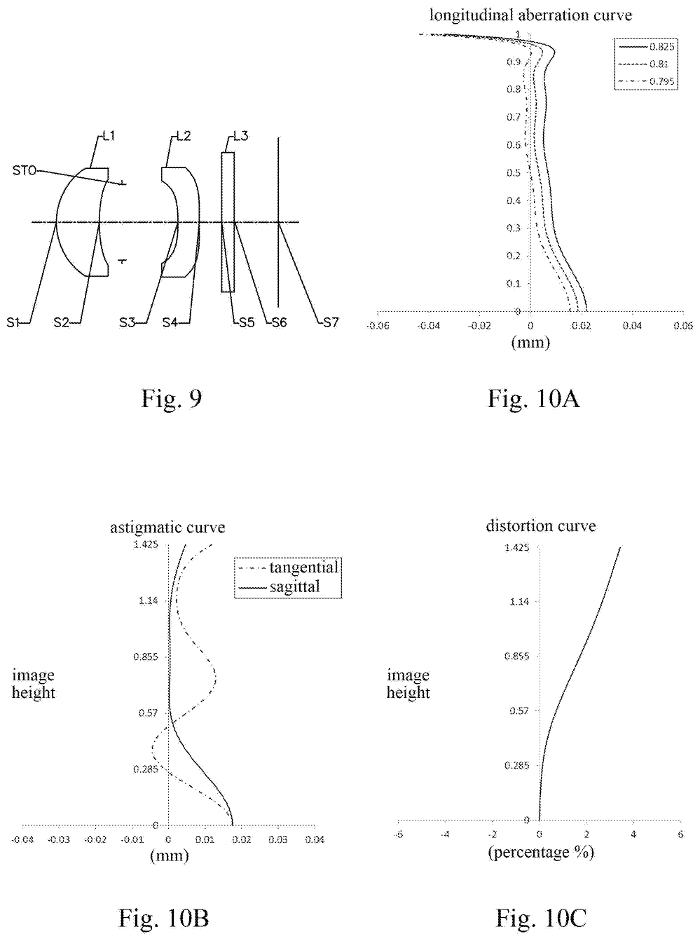

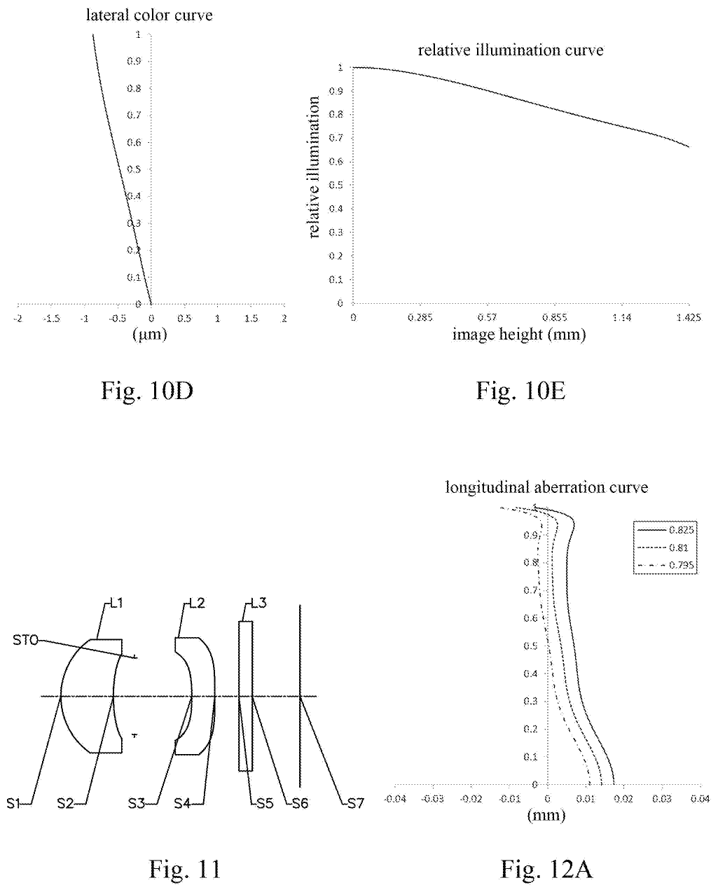

An iris lens assembly according to embodiment 5 of the present disclosure is described below with reference to FIGS. 9-10E. FIG. 9 illustrates a schematic structural diagram of the iris lens assembly according to embodiment 5 of the present disclosure.

As shown in FIG. 9, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 13 shows the surface type, the radius of curvature, the thickness, the material and the conic coefficient of each lens of the iris lens assembly in embodiment 5. The radius of curvature and the thickness are shown in millimeters (mm). Table 14 shows the high-order coefficients A₄, A₆, A₈, A₁₀, A₁₂, A₁₄ and A₁₆ that can be applied to the aspheric mirror surfaces in embodiment 5. Table 15 shows the total effective focal length f of the iris lens assembly, the effective focal length f1 of the first lens L1, the effective focal length f2 of the second lens L2, the total optical length TTL of the iris lens assembly, and the half of the diagonal length ImgH of the effective pixel area of the electronic photosensitive element on the image plane S7 of the iris lens assembly of embodiment 5. A surface type of each aspheric surface may be defined by the formula (1) provided in embodiment 1.

TABLE 13

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| S1 | aspheric | 1.1089 | 0.7221 | 1.537 | 56.11 | 0.2219 |
| S2 | aspheric | 2.5391 | 0.3818 | | | 1.0000 |
| STO | spherical | infinite | 0.9414 | | | |
| S3 | aspheric | −2.8737 | 0.3593 | 1.622 | 23.53 | −4.0689 |
| S4 | aspheric | 59.3122 | 0.3755 | | | 1.0000 |
| S5 | spherical | infinite | 0.2100 | 1.517 | 64.17 | |
| S6 | spherical | infinite | 0.7423 | | | |
| S7 | spherical | infinite | | | | |

TABLE 14

| surface | | | | | | | |
|---|---|---|---|---|---|---|---|
| number | A4 | A6 | A8 | A10 | A12 | A14 | A16 |
| S1 | −2.2534E−02 | −3.8220E−02 | 1.0513E−01 | −2.5572E−01 | 2.6669E−01 | −1.2275E−01 | 0.0000E+00 |
| S2 | 5.2950E−02 | 2.1007E−01 | −8.5353E−01 | 3.3212E+00 | −5.9250E+00 | 4.7546E+00 | 0.0000E+00 |
| S3 | −3.8866E−01 | −3.1806E+00 | 2.6058E+01 | −1.2681E+02 | 3.4131E+02 | −4.8881E+02 | 2.8285E+02 |
| S4 | −3.5154E−01 | −1.3362E−01 | 1.4914E+00 | −4.9150E+00 | 8.1112E+00 | −6.9308E+00 | 2.4034E+00 |

TABLE 15

| parameter | f (mm) | f1 (mm) | f2 (mm) | TTL (mm) | ImgH (mm) |
|---|---|---|---|---|---|
| numerical value | 4.13 | 3.12 | −4.40 | 3.73 | 1.43 |

FIG. 10A illustrates a longitudinal aberration curve of the iris lens assembly according to embodiment 5, representing deviations of focal points of light of different wavelengths converged after passing through the iris lens assembly. FIG. 10B illustrates an astigmatic curve of the iris lens assembly according to embodiment 5, representing a curvature of a meridional image plane and a curvature of a sagittal image plane. FIG. 10C illustrates a distortion curve of the iris lens assembly according to embodiment 5, representing amounts of distortion at different viewing angles. FIG. 10D illustrates a lateral color curve of the iris lens assembly according to embodiment 5, representing deviations of different image heights on an image plane after light passes through the iris lens assembly. FIG. 10E illustrates a relative illumination curve of the iris lens assembly according to embodiment 5, representing relative illumination corresponding to different image heights on the image plane. It can be known according to FIGS. 10A-10E that the iris lens assembly provided in embodiment 5 can achieve a good image quality.

### Embodiment 6

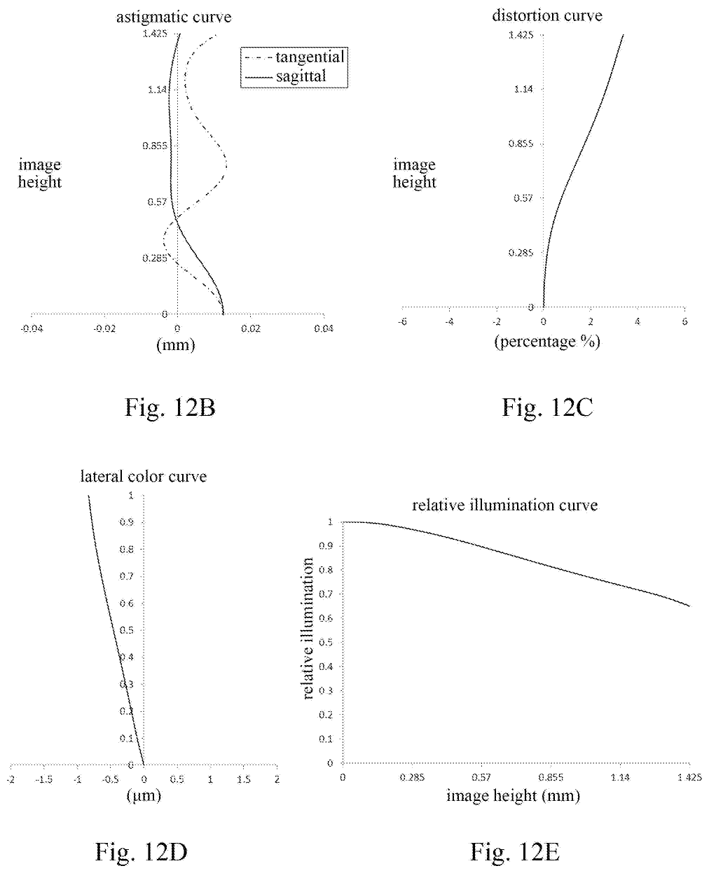

An iris lens assembly according to embodiment 6 of the present disclosure is described below with reference to FIGS. 11-12E. FIG. 11 illustrates a schematic structural diagram of the iris lens assembly according to embodiment 6 of the present disclosure.

As shown in FIG. 11, the iris lens assembly includes, along an optical axis, two lenses L1 and L2 arranged in sequence from an object side to an image side. A first lens L1 has an object side surface S1 and an image side surface S2, and a second lens L2 has an object side surface S3 and an image side surface S4. Alternatively, the iris lens assembly may further include a filter L3 having an object side surface S5 and an image side surface S6. The filter L3 may be an infrared (IR) filter, and a bandpass wave band of the filter ranges from about 785 nm to about 835 nm. In the iris lens assembly of this embodiment, an aperture STO for limiting light beams may also be arranged between the object side and the first lens L1, to improve the image quality. Light from an object sequentially passes through the surfaces S1 to S6 and finally forms an image on an image plane S7.

Table 16 shows the surface type, the radius of curvature, the thickness, the material and the conic coefficient of each lens of the iris lens assembly in embodiment 6. The radius of curvature and the thickness are shown in millimeters (mm). Table 17 shows the high-order coefficients A₄, A₆, A₈, A₁₀, A₁₂, A₁₄ and A₁₆ that can be applied to the aspheric mirror surfaces in embodiment 6. Table 18 shows the total effective focal length f of the iris lens assembly, the effective focal length f1 of the first lens L1, the effective focal length f2 of the second lens L2, the total optical length TTL of the iris lens assembly, and the half of the diagonal length ImgH of the effective pixel area of the electronic photosensitive element on the image plane S7 of the iris lens assembly of embodiment 6. A surface type of each aspheric surface may be defined by the formula (1) provided in embodiment 1.

TABLE 16

| | | | | material | | |
|---|---|---|---|---|---|---|
| surface | surface | radius of | | refractive | dispersion | conic |
| number | type | curvature | thickness | index | coefficient | coefficient |
| OBJ | spherical | infinite | 260.0000 | | | |
| S1 | aspheric | 1.0977 | 0.8187 | 1.537 | 56.11 | 0.1520 |
| S2 | aspheric | 2.2950 | 0.3290 | | | 0.9960 |
| STO | spherical | infinite | 0.8960 | | | |
| S3 | aspheric | −3.0685 | 0.3580 | 1.622 | 23.53 | 0.4223 |
| S4 | aspheric | −123.0086 | 0.3765 | | | −3.1327 |
| S5 | spherical | infinite | 0.2100 | 1.517 | 64.17 | |
| S6 | spherical | infinite | 0.7433 | | | |
| S7 | spherical | infinite | | | | |

TABLE 17

| surface | | | | | | | |
|---|---|---|---|---|---|---|---|
| number | A4 | A6 | A8 | A10 | A12 | A14 | A16 |
| S1 | −1.9164E−02 | −2.7257E−02 | 7.4036E−02 | −1.8945E−01 | 2.0138E−01 | −9.5530E−02 | 0.0000E+00 |
| S2 | 6.8147E−02 | 1.6641E−01 | −4.4392E−01 | 1.9723E+00 | −3.7066E+00 | 3.6909E+00 | 0.0000E+00 |
| S3 | −3.5832E−01 | −2.7831E+00 | 2.1916E+01 | −1.0353E+02 | 2.6915E+02 | −3.7250E+02 | 2.0669E+02 |
| S4 | −3.2472E−01 | −2.1106E−01 | 1.6033E+00 | −4.9099E+00 | 7.7491E+00 | −6.4143E+00 | 2.1613E+00 |

TABLE 18

| parameter | f (mm) | f1 (mm) | f2 (mm) | TTL (mm) | ImgH (mm) |
|---|---|---|---|---|---|
| numerical value | 4.06 | 3.16 | −5.07 | 3.73 | 1.43 |

FIG. 12A illustrates a longitudinal aberration curve of the iris lens assembly according to embodiment 6, representing deviations of focal points of light of different wavelengths converged after passing through the iris lens assembly. FIG. 12B illustrates an astigmatic curve of the iris lens assembly according to embodiment 6, representing a curvature of a meridional image plane and a curvature of a sagittal image plane. FIG. 12C illustrates a distortion curve of the iris lens assembly according to embodiment 6, representing amounts of distortion at different viewing angles. FIG. 12D illustrates a lateral color curve of the iris lens assembly according to embodiment 6, representing deviations of different image heights on an image plane after light passes through the iris lens assembly. FIG. 12E illustrates a relative illumination curve of the iris lens assembly according to embodiment 6, representing relative illumination corresponding to different image heights on the image plane. It can be known according to FIGS. 12A-12E that the iris lens assembly provided in embodiment 6 can achieve a good image quality.

To sum up, embodiment 1 to embodiment 6 respectively satisfy the relations shown in Table 19 below.

TABLE 19

| | embodiment | | | | | |
|---|---|---|---|---|---|---|
| conditional formula | 1 | 2 | 3 | 4 | 5 | 6 |
| T12/TTL | 0.43 | 0.39 | 0.37 | 0.35 | 0.35 | 0.33 |
| DT11/DT22 | 0.80 | 0.86 | 0.95 | 0.91 | 0.99 | 0.97 |
| ET1max/ET1min | 1.20 | 1.27 | 1.40 | 1.10 | 1.20 | 1.13 |
| CRAmax (°) | 24.14 | 24.31 | 27.92 | 28.84 | 29.03 | 28.93 |
| ET1/CT1 | 0.74 | 0.67 | 0.58 | 0.67 | 0.53 | 0.60 |
| TTL/(ImgH*f) (mm⁻¹) | 0.67 | 0.66 | 0.61 | 0.61 | 0.63 | 0.64 |
| DT12/DT22 | 0.72 | 0.77 | 0.86 | 0.75 | 0.78 | 0.73 |
| DT22/ImgH | 0.79 | 0.76 | 0.56 | 0.58 | 0.65 | 0.64 |
| \|R4/f\| | 1.30 | 2.68 | 2.98 | 0.65 | 14.38 | 30.29 |
| R2/f1 | 1.25 | 1.09 | 0.91 | 0.52 | 0.81 | 0.73 |

The present disclosure further provides a camera device, having a photosensitive element which may be a photosensitive charge-coupled device (CCD) or a complementary metal-oxide semiconductor (CMOS) element. The camera device may be an independent camera device such as a digital camera, or may be a camera module integrated in a mobile electronic device such as a mobile phone. The camera device is equipped with the iris lens assembly described above.

The foregoing descriptions are merely illustrations of the preferred embodiments of the present disclosure and the applied technical principles. It should be appreciated by those skilled in the art that the inventive scope of the present disclosure is not limited to the technical solutions formed by the particular combinations of the above technical features. The inventive scope should also cover other technical solutions formed by any combinations of the above technical features or equivalent features thereof without departing from the concept of the invention, for example, technical solutions formed by replacing the above features as disclosed in the present disclosure with (but not limited to) technical features having similar functions.

1. An iris lens assembly, comprising sequentially a first lens and a second lens from an object side to an image side along an optical axis,
wherein the first lens has a positive focal power, an object side surface of the first lens is a convex surface, and an image side surface of the first lens is a concave surface; and
the second lens has a negative focal power,
wherein a spacing distance T12 between the first lens and the second lens on the optical axis and a distance TTL from the object side surface of the first lens to an image plane of the iris lens assembly on the optical axis satisfy: T12/TTL>0.32.

2. The iris lens assembly according to claim 1, wherein an effective radius DT11 of the object side surface of the first lens and an effective radius DT22 of an image side surface of the second lens2 satisfy: 0.7<DT11/DT22<1.

3. The iris lens assembly according to claim 1, wherein a maximum thickness ET1max of the first lens in a direction parallel to the optical axis and a minimum thickness ET1min of the first lens in the direction parallel to the optical axis satisfy: 1<ET1max/ET1min<1.45.

4. (canceled)

5. The iris lens assembly according to claim 1, wherein an edge thickness ET1 of the first lens and a center thickness CT1 of the first lens on the optical axis satisfy: 0.5<ET1/CT1<1.

6. The iris lens assembly according to claim 1, wherein the iris lens assembly further comprises an infrared (IR) filter arranged between the second lens and the image plane of the iris lens assembly.

7. The iris lens assembly according to claim 6, wherein a bandpass wave band of the infrared (IR) filter ranges from 785 nm to 835 nm.

8. The iris lens assembly according to claim 1, wherein 0.4 mm⁻¹<TTL/(ImgH*f)<0.7 mm⁻¹,
wherein TTL is the distance from the object side surface of the first lens to the image plane of the iris lens assembly on the optical axis;
ImgH is a half of a diagonal length of an effective pixel area of an electronic photosensitive element on the image plane of the iris lens assembly; and
f is a total effective focal length of the iris lens assembly.

9. The iris lens assembly according to claim 1, wherein an effective radius DT12 of the image side surface of the first lens and an effective radius DT22 of an image side surface of the second lens satisfy: 0.7<DT12/DT22<1.

10. The iris lens assembly according to claim 1, wherein an effective radius DT22 of an image side surface of the second lens and ImgH, ImgH being a half of a diagonal length of an effective pixel area of an electronic photosensitive element on the image plane of the iris lens assembly, satisfy: 0.5<DT22/ImgH<1.

11. The iris lens assembly according to claim 6, wherein the iris lens assembly further comprises an aperture diaphragm arranged between the object side and the first lens, and
a radius of curvature R4 of the image side surface of the second lens and the total effective focal length f of the iris lens assembly satisfy: |R4/f|<3.

12. The iris lens assembly according to claim 1, wherein the iris lens assembly further comprises an aperture diaphragm arranged between the first lens and the second lens, and
a radius of curvature R2 of the image side surface of the first lens and an effective focal length f1 of the first lens satisfy: 0.5<R2/f1<0.9.

13. An iris lens assembly, comprising sequentially a first lens and a second lens from an object side to an image side along an optical axis,
wherein the first lens has a positive focal power, an object side surface of the first lens is a convex surface, and an image side surface of the first lens is a concave surface; and
the second lens has a negative focal power,
wherein an effective radius DT11 of the object side surface of the first lens and an effective radius DT22 of an image side surface of the second lens satisfy: 0.7<DT11/DT22<1.

14. The iris lens assembly according to claim 13, wherein a maximum thickness ET1max of the first lens in a direction parallel to the optical axis and a minimum thickness ET1min of the first lens in the direction parallel to the optical axis satisfy: 1<ET1max/ET1min<1.45.

15. (canceled)

16. The iris lens assembly according to claim 14, wherein the effective radius DT22 of the image side surface of the second lens and ImgH, ImgH being a half of a diagonal length of an effective pixel area of an electronic photosensitive element on an image plane of the iris lens assembly, satisfy: 0.5<DT22/ImgH<1.

17. (canceled)

18. The iris lens assembly according to claim 14, wherein an edge thickness ET1 of the first lens and a center thickness CT1 of the first lens on the optical axis satisfy: 0.5<ET1/CT1<1.

19. The iris lens assembly according to claim 13, further comprising an electronic photosensitive element disposed on an image plane of the iris lens assembly, wherein a maximum incident angle CRAmax of a chief incident ray on the electronic photosensitive element satisfies: CRAmax<30°.

20. The iris lens assembly according to claim 13, wherein the iris lens assembly further comprises an infrared (IR) filter arranged between the second lens and an image plane of the iris lens assembly.

21. (canceled)

22. The iris lens assembly according to claim 13, wherein 0.4 mm⁻¹<TTL/(ImgH*f)<0.7 mm⁻¹,
wherein TTL is a distance from the object side surface of the first lens to an image plane of the iris lens assembly on the optical axis;
ImgH is a half of a diagonal length of an effective pixel area of an electronic photosensitive element on an image plane of the iris lens assembly; and
f is a total effective focal length of the iris lens assembly.

23. The iris lens assembly according to claim 13, wherein the iris lens assembly further comprises an aperture diaphragm arranged between the object side and the first lens, and
a radius of curvature R4 of the image side surface of the second lens and a total effective focal length f of the iris lens assembly satisfy: |R4/f|<3.

24. The iris lens assembly according to claim 14, wherein the iris lens assembly further comprises an aperture diaphragm arranged between the first lens and the second lens, and
a radius of curvature R2 of the image side surface of the first lens and an effective focal length f1 of the first lens satisfy: 0.5<R2/f1<0.9.
